(19) United States
(12) Patent Application Publication
(10) Pub. No.: US 2019/0162333 A1
(43) Pub. Date: May 30, 2019

(54) FUEL HOSE

(71) Applicant: SOLVAY SPECIALTY POLYMERS ITALY S.P.A., Bollate (IT)

(72) Inventors: Matteo FANTONI, Vanzaghello (IT); Marco APOSTOLO, Senago (IT); Stefano MAURI, Giussano (IT)

(21) Appl. No.: 16/320,916

(22) PCT Filed: Jul. 24, 2017
(86) PCT No.: PCT/EP2017/068586

§ 371 Date: Jan. 25, 2019

Related U.S. Application Data
(60) Provisional application No. 62/367,088, filed on Jul. 26, 2016.

(30) Foreign Application Priority Data
Jan. 10, 2017 (EP) 17150844.3

(51) Int. Cl. F16L 11/08; B32B 27/32; B32B 27/28; B32B 27/08; B32B 1/08

(52) U.S. Cl. CPC F16L 11/082; B32B 25/16; B32B 27/283; B32B 27/08; B32B 1/08; B32B 2250/02; B32B 2255/10; B32B 2255/28; B32B 2264/102; B32B 2264/108; B32B 2307/546; B32B 2307/554; B32B 2597/00; B32B 2307/7242; B32B 2307/7265; B32B 2307/732; B32B 27/322

(57) ABSTRACT

The present invention relates to a fuel hose made from a metal-plated elastomer and to a method for its manufacturing.

### CROSS-REFERENCE TO RELATED APPLICATIONS

This application claims priority to U.S. provisional application No. 62/367,088, filed on 26 Jul. 2016, and to European application No. 17150844.3, filed on 10 Jan. 2017, the whole content of each of these applications being incorporated herein by reference for all purposes.

### TECHNICAL FIELD

The present invention relates to a fuel hose made from an elastomer composition and to a method for its manufacturing.

### BACKGROUND ART

(Per)fluoroelastomers are known to be relatively chemically inert, thermally stable polymers, owing primarily to the strength of the carbon-fluorine bonds present in the molecule.

Because of their properties, the (per)fluoroelastomers are desirable in many applications which require elastomeric materials able to provide high performances, such as withstanding to high temperatures.

However, a great number of applications in the field of oil and gas, electronics, automotive, and aerospace require the (per)fluoroelastomers, for example, to have electrical and thermal conductivity or to provide a barrier to gases and liquids.

With the aim to provide (per)fluoroelastomers having the above properties, it has been proposed in the art to adhesively bond metals to (per)fluoroelastomers.

Conventional approaches, such as for example vapour coating, sputtering or ion bombardment processes, comprise chemically or physically roughen the metal surface, followed by a thermal fusion or adhering with the intermediary of an adhesive layer (also called primer) between the outmost fluoropolymer layer and the metal, which also has to possess outstanding adhesion properties towards additional top-coat (outer) layers made from fluoropolymers.

For example, WO 2013/101822 (3M INNOVATIVE PROPERTIES CO.) discloses a fluoroelastomer material bearing a conductive metal overlayer bound to said fluoroelastomer material through a thin layer of titanium. The method for making said material comprises the steps of (a) providing a fluoroelastomer material, optionally (d) exposure of the fluoroelastomer to oxygen plasma, (b) applying a layer of titanium metal to the fluoroelastomer material by a vapour coating method, (c) applying a metal overlayer to the fluoroelastomer material by a vapour coating method, and optionally (e) electroplating the fluoroelastomer.

However, high performing polymers—including, in particular, (per)fluoroelastomers and silicone rubbers—have low surface energy, and consequently poor adhesion with respect to metal materials.

Thus, the high performing polymers coated with metal layers using conventional approaches can suffer of problems such as easy peeling of the metallic coating from the substrate and poor durability of the coating.

In particular, defects in the metallic layer applied on the surface of the elastomer can become particularly evident when the elastomer undergoes to elongation, resulting in a loss of continuity in the metal layer and consequent decrease or loss of the properties imparted by the metal coating, such as for example barrier to fluids and thermal/electrical conductivity.

For example, FR 2139998 (DR. INC. MAX SCHLOTTER) discloses plastics and articles made therefrom which are metal plated by conditioning their surface by a treatment with sulfur trioxide vapor or a sulfur trioxide containing atmosphere. In particular, Example 23 discloses the treatment of a soft rubber plate, which is first exposed to the sulfur trioxide vapor phase, then treated with an activating solution, a reducing solution and then chemically nickel plated. Then, the metal layer is reinforced by electroplating with a copper deposit. The authors concluded that “when heating the plates after copper plating to 80° C. for two hours, the adherence of the copper layer to the plate is such that the metal layer does not separate from the rubber plate but the rubber plate itself becomes torn”.

Thus, the method disclosed in FR 2139998 is not suitable for metallizing fuel hoses: during use fuel hose typically undergo to bending and hence the risk of tears and/or lacerations must be reduced as far as possible.

Metallization has also been disclosed for semi-crystalline polymers or liquid crystal polymers (for example in WO 2014/154733 (SOLVAY SPECIALTY POLYMERS S.P.A.) and US 2009/0017319 A (FRAMATOME CONNECTORS INT.) . However, semi-crystalline polymers, such as ECTFE, and elastomers have different chemical-physical properties and are used in different applications. Also, semi-crystalline polymers do not undergo to elongation and, hence, they are not affected by the problems typically encountered when using elastomers.

US 2007/0098978 (DAIKIN) discloses a surface coated sealing material having chemical resistance, plasma resistance and non-sticking, while keeping strength, hardness and sealing property of a soft substrate. The sealing material has a coating film comprising a metal or metallic compound selected from the group consisting of metals, metal oxides, metal nitrides, metal carbides and complex thereof. The soft material used as substrate is not particularly limited and can be selected from fluorine resins and fluorine rubbers, fluorosilicon rubbers, silicon rubber, NBR and EPDM.

As a process for forming a coating film comprising a metal or a metallic compound, a vacuum film forming process is used. However, this technique on the one hand is performed under vacuum, with high costs, and most importantly does not allow to form chemical bonds between the substrate and the metal in the coating layer. This drawback in the adhesion adversely affects the adhesion between the substrate and the coating layer and is worsened when the substrate is an elastomer that undergoes to elongation and bending.

WO 2016/079230 (SOLVAY SPECIALTY POLYMERS ITALY S.P.A.) broadly relates to a multi-layered elastomer article made of an elastomeric composition comprising at least one elastomer, said article having at least one surface having nitrogen-containing groups and at least one layer adhered to said surface comprising at least one metal compound. However, this patent application does not disclose articles in the form of fuel hoses wherein the external surface comprises at least one metal compound.

### SUMMARY OF INVENTION

The Applicant faced the problem to provide a hose suitable for applications such as fuel transportation, wherein high chemical resistance and impermeability are required.

Thus, in a first aspect, the present invention relates to a hose comprising at least one layer [layer L] made from a composition comprising at least one elastomer, said layer L having an internal surface [surface (Sᵢ)] and an external surface [surface (S_{e-NM})], said surface (S_{e-NM}) comprising nitrogen-containing groups [groups (N)] and at least one metal compound [compound (M)].

Advantageously, the hose according to the present invention is impermeable to gases and liquids, and can withstand extreme environmental conditions due to its chemical resistance, abrasion resistance and wear resistance, while maintaining its typical flexibility and mechanical properties. Accordingly, the hose according to the present invention is used for the transportation of fuel.

Thus, in a second aspect, the present invention relates to a method for supplying or transporting fuel drawn up from a fuel tank to fuel injection valves of an engine, wherein the supply or transport of the fuel is performed using the hose as defined above.

Then, in a third aspect, the present invention relates to a method for manufacturing a hose, said method comprising the steps of:
(i) providing a composition [composition (C)] comprising at least one elastomer;
(ii) processing said composition (C), so as to providing a hose having an internal surface [surface (Sᵢ)] and an external surface [surface (Sₑ)];
(iii) forming nitrogen-containing groups [groups (N)] onto said surface (Sₑ) so as to provide a hose having a nitrogen-containing external surface [surface (S_{e-N})];
(iv) contacting said surface (S_{e-N}) with a composition [composition (C1)] comprising at least one metallization catalyst, so as to provide a hose having an external surface containing groups (N) and at least one metallization catalyst [surface (S_{e-NC})];
(v) contacting said surface (S_{e-NC}) with a composition [composition (C2)] containing at least one metal compound [compound (M1)], so as to provide a hose an internal surface [surface (Sᵢ)] and an external surface [surface (S_{e-NM})], said surface (S_{e-NM}) comprising groups (N) and at least one compound (M).

### DESCRIPTION OF EMBODIMENTS

Preferably, said groups (N) are grafted onto said surface (S_{e-NM}).

Without being bounded by any theory, the Applicant believes that at least part of said groups (N) grafted onto said surface (S_{e-NM}) form chemical bonds with said at least one compound (M), thus obtaining an outstanding adhesion between the elastomer and the metal compound.

The expression “chemical bonds” is intended to indicate any type of chemical bond, such as for example covalent bond, ionic bond, dipolar (or coordinate) bond, between at least part of groups (N) grafted on the surface of the elastomer and compound (M).

The term “elastomer” as used within the present description and in the following claims indicates amorphous polymers or polymers having a low degree of crystallinity (crystalline phase less than 20% by volume) and a glass transition temperature value (T_{g}), measured according to ASTM D3418, below room temperature. More preferably, the elastomer according to the present invention has a T_{g} below 5° C., even more preferably below 0° C.

Preferably, said elastomer comprises recurring units derived from at least one at least one (per)fluorinated monomer and/or at least one hydrogenated monomer. In a preferred embodiment, said monomers are free of nitrogen atoms.

By the expression “at least one (per)fluorinated monomer, it is hereby intended to denote a polymer comprising recurring units derived from one or more than one (per)fluorinated monomers. In the rest of the text, the expression “(per)fluorinated monomers” is understood, for the purposes of the present invention, both in the plural and the singular, that is to say that it denote both one or more than one fluorinated monomers as defined above. The prefix “(per)” in the expression “(per)fluorinated monomer” and in the term “(per)fluoroelastomer” means that the monomer or the elastomer can be fully or partially fluorinated.

Non limitative examples of suitable (per)fluorinated monomers include, notably, the followings:
C₃-C₈ perfluoroolefins, such as tetrafluoroethylene (TFE) and hexafluoropropene (HFP);
C₂-C₈ hydrogenated fluoroolefins, such as vinylidene fluoride (VDF), vinyl fluoride, 1,2-difluoroethylene and trifluoroethylene (TrFE);
chloro- and/or bromo- and/or iodo-C₂-C₆ fluoroolefins, such as chlorotrifluoroethylene (CTFE);
CH₂═CH—R_{f0} wherein R_{f0} is a C₁-C₆ (per)fluoroalkyl or a C₁-C₆ (per)fluorooxyalkyl having one or more ether groups;
CH₂═CFOR_{f1}, wherein R_{f1} is a C₁-C₆ fluoro- or perfluoroalkyl group, such as CF₃, C₂F₅, C₃F₇;
CF₂═CFOR_{f2}, wherein R_{f2} is C₁-C₁₂ alkyl or (per)fluoroalkyl group, such as CF₃, C₂F₅, C₃F₇; C₁-C₁₂ oxyalkyl; C₁-C₁₂ (per)fluorooxyalkyl group, optionally comprising one or more ether groups, such as perfluoro-2-propoxy-propyl; a group of formula —CF₂OR_{f3} in which R_{f3} is a C₁-C₆ fluoro- or perfluoroalkyl or a C₁-C₆ (per)fluorooxyalkyl group comprising one or more ether groups, such as —C₂F₅—O—CF₃; or R_{f2} comprises a carboxylic or sulfonic acid group, in its acid, acid halide or salt form;
fluorodioxoles, such as perfluorodioxoles;
fluorosilanes, such as CF₃—C₂H₄—Si(R_{f5})₃ or Ar—Si(R_{f5})₃ wherein each of R_{f5} is independently selected from Cl, C₁-C₃ alkyl or C₁-C₃ alkoxy, and Ar is a phenyl ring optionally substituted with a C₁-C₆ fluoro- or perfluoroalkyl group, e.g. CF₃, C₂F₅, C₃F₇ or a C₁-C₆ (per)fluorooxyalkyl group comprising one or more ether groups, such as —C₂F₅—O—CF₃; and CH₂═CH₂—Si(R_{f6})₃ wherein each of R_{f6} is independently selected from H, F and C₁-C₃ alkyl, provided that at least one of said R_{f6} is F.

The expressions “at least one hydrogenated monomer” is intended to mean that the polymer may comprise recurring units derived from one or more than one hydrogenated monomers.

By the expression “hydrogenated monomer”, it is hereby intended to denote an ethylenically unsaturated monomer comprising at least one hydrogen atom and free from fluorine atoms.

Non limitative examples of suitable hydrogenated monomers include, notably, non-fluorinated monomers such as C₂-C₈ non-fluorinated olefins (OI), in particular C₂-C₈ non-fluorinated alpha-olefins (OI), including ethylene, propylene, 1-butene; diene monomers; vinyl monomers such as vinyl acetate and methyl-vinyl ether (MVE); acrylic monomers, like methyl methacrylate, butyl acrylate; styrene monomers, like styrene and p-methylstyrene; nitrile rubber; and silicon-containing monomers.

According to a preferred embodiment, said elastomer is a (per)fluoro-elastomer or a silicone elastomer.

Preferably, said (per)fluoro-elastomer has a T_{g} of less than 0° C., more preferably of less than −10° C., as measured as measured according to ASTM D-3418.

Typically, said (per)fluoro-elastomer comprises recurring units derived from the (per)fluorinated monomers cited above.

More preferably, said (per)fluoro-elastomer comprises recurring units derived from:
C₃-C₈ perfluoroolefins, such as tetrafluoroethylene (TFE) and hexafluoropropene (HFP);
C₂-C₈ hydrogenated fluoroolefins, such as vinylidene fluoride (VDF), vinyl fluoride, 1,2-difluoroethylene and trifluoroethylene (TrFE);
CF₂═CFOR_{f1}, wherein R_{f1} is a C₁-C₆ fluoro- or perfluoroalkyl group, such as CF₃, C₂F₅, C₃F₇, or a group of formula —CFOCF₂OR_{f2} wherein R_{f2} is a C₁-C₆ fluoro- or perfluoroalkyl group, e.g. CF₃, C₂F₅, C₃F₇;
fluorosilanes, such as CF₃—C₂H₄—Si(R_{f3})₃ wherein each of R_{f3} is independently selected from Cl, C₁-C₃ alkyl or C₁-C₃ alkoxy, and CH₂═CH₂—Si(R_{f4})₃ wherein each of R_{f4} is selected from H, F and C₁-C₃ alkyl.

Optionally, said (per)fluoroelastomer further comprises recurring units derived from at least one bis-olefin.

Non limiting examples of suitable bis-olefins are selected from those of formulae below:
R₁R₂C═CH—(CF₂)ⱼ—CH═CR₃R₄ wherein j is an integer between 2 and 10, preferably between 4 and 8, and R₁, R₂, R₃, R₄, equal or different from each other, are —H, —F or C₁-C₅ alkyl or (per)fluoroalkyl group;
A₂C═CB-O-E-O—CB═CA₂, wherein each of A, equal or different from each other, is independently selected from —F, —Cl, and —H; each of B, equal or different from each other is independently selected from —F, —Cl, —H and —OR_{B}, wherein R_{B} is a branched or straight chain alkyl radical which can be partially, substantially or completely fluorinated or chlorinated; E is a divalent group having 2 to 10 carbon atoms, optionally fluorinated, which may be inserted with ether linkages; preferably E is a —(CF₂)_{z}— group, with z being an integer from 3 to 5; and
R₆R₇C═CR₅-E-O—CB═CA₂, wherein E, A and B have the same meaning as above defined; R₅, R₆, R₇, equal or different from each other, are —H, —F or C₁-C₅ alkyl or fluoroalkyl group.

When a bis-olefin is employed, the resulting (per)fluoroelastomer typically comprises from 0.01% to 5% by moles of units deriving from the bis-olefin with respect to the total amount of units in the polymer.

Optionally, said (per)fluoroelastomer may comprise cure sites, either as pendant groups bonded to certain recurring units or as ends groups of the polymer chain, said cure sites comprising at least one iodine or bromine atom, more preferably at least one iodine atom.

Among cure-site containing recurring units, mention can be notably made of:

(CSM-1) iodine or bromine containing monomers of formula:

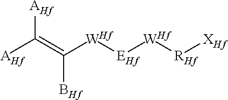

wherein each of A_{Hf}, equal to or different from each other and at each occurrence, is independently selected from F, Cl, and H; B_{Hf} is any of F, Cl, H and OR^{Hf}_{B}, wherein R^{Hf}_{B} is a branched or straight chain alkyl radical which can be partially, substantially or completely fluorinated or chlorinated; each of W^{Hf} equal to or different from each other and at each occurrence, is independently a covalent bond or an oxygen atom; E_{Hf} is a divalent group having 2 to 10 carbon atom, optionally fluorinated; R_{Hf} is a branched or straight chain alkyl radical, which can be partially, substantially or completely fluorinated; and R_{Hf} is a halogen atom selected from the group consisting of Iodine and Bromine; which may be inserted with ether linkages; preferably E is a —(CF₂)ₘ— group, with m being an integer from 3 to 5;

(CSM-2) ethylenically unsaturated compounds comprising cyanide groups, possibly fluorinated.

Among cure-site containing monomers of type (CSM1), preferred monomers are those selected from the group consisting of: (CSM1-A) iodine-containing perfluorovinylethers of formula:

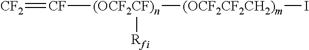

with m being an integer from 0 to 5 and n being an integer from 0 to 3, with the provisio that at least one of m and n is different from 0, and R_{fi} being F or CF₃; (as notably described in patents U.S. Pat. No. 4,745,165 (AUSIMONT SPA), U.S. Pat. No. 4,564,662 (MINNESOTA MINING) and EP 199138 (DAIKIN IND LTD); and

(CSM-1B) iodine-containing ethylenically unsaturated compounds of formula:

CX¹X²═CX³—(CF₂CF₂)ₚ—I

wherein each of X¹, X² and X³, equal to or different from each other, are independently H or F; and p is an integer from 1 to 5; among these compounds, mention can be made of CH₂═CHCF₂CF₂I, I(CF₂CF₂)₂CH═CH₂, ICF₂CF₂CF═CH₂, I(CF₂CF₂)₂CF═CH₂;

(CSM-1C) iodine-containing ethylenically unsaturated compounds of formula:

CHR═CH—Z—CH₂CHR—I

wherein R is H or CH₃, Z is a C₁-C₁₈ (per)fluoroalkylene radical, linear or branched, optionally containing one or more ether oxygen atoms, or a (per)fluoropolyoxyalkylene radical; among these compounds, mention can be made of CH₂═CH—(CF₂)₄CH₂CH₂I, CH₂═CH—(CF₂)₆CH₂CH₂I, CH₂═CH—(CF₂)₈CH₂CH₂I, CH₂═CH—(CF₂)₂CH₂CH₂I;

(CSM-1D) bromo and/or iodo alpha-olefins containing from 2 to 10 carbon atoms such as bromotrifluoroethylene or bromotetrafluorobutene described, for example, in U.S. Pat. No. 4,035,565 (DU PONT) or other compounds bromo and/or iodo alpha-olefins disclosed in U.S. Pat. No. 4,694,045 (DU PONT) .

Among cure-site containing monomers of type (CSM2), preferred monomers are those selected from the group consisting of:

(CSM2-A) perfluorovinyl ethers containing cyanide groups of formula CF₂═CF—(OCF₂CFX^{CN})ₘ—O—(CF₂)ₙ—CN, with X^{CN} being F or CF₃, m being 0, 1, 2, 3 or 4; n being an integer from 1 to 12;

(CSM2-B) perfluorovinyl ethers containing cyanide groups of formula CF₂═CF—(OCF₂CFX^{CN})ₘ—O—CF₂—CF(CF₃)—CN, with X^{CN} being F or CF₃, m′ being 0, 1, 2, 3 or 4.

Specific examples of cure-site containing monomers of type CSM2-A and CSM2-B suitable to the purposes of the present invention are notably those described in patents U.S. Pat. No. 4,281,092 (DU PONT) , U.S. Pat. No. 5,447,993 (DU PONT) and U.S. Pat. No. 5,789,489 (DU PONT) .

Preferably, said (per)fluoroelastomer comprises iodine or bromine cure sites in an amount of 0.001 to 10% wt. Among these, iodine cure sites are those selected for maximizing curing rate, so that (per)fluoroelastomers comprising iodine cure-sites are preferred.

According to this embodiment, for ensuring acceptable reactivity it is generally understood that the content of iodine and/or bromine in the (per)fluoroelastomer should be of at least 0.05% wt., preferably of at least 0.1% wt., more preferably of at least 0.15% wt., with respect to the total weight of the (per)fluoroelastomer.

On the other side, amounts of iodine and/or bromine not exceeding preferably 7% wt., more specifically not exceeding 5% wt., or even not exceeding 4% wt., with respect to the total weight of the (per)fluoroelastomer, are those generally selected for avoiding side reactions and/or detrimental effects on thermal stability.

These iodine or bromine cure sites of these preferred embodiments of the invention might be comprised as pending groups bound to the backbone of the (per)fluoroelastomer polymer chain (by means of incorporation in the (per)fluoroelastomer chain of recurring units derived from monomers of (CSM-1) type, as above described, and preferably of monomers of (CSM-1A) to (CSM1-D), as above detailed) or might be comprised as terminal groups of said polymer chain.

According to a first embodiment, the iodine and/or bromine cure sites are comprised as pending groups bound to the backbone of the (per)fluoroelastomer polymer chain. The (per)fluoroelastomer according to this embodiment generally comprises recurring units derived from iodine or bromine containing monomers (CSM-1) in amounts of 0.05 to 5 mol per 100 mol of all other recurring units of the (per)fluoroelastomer, so as to advantageously ensure above mentioned iodine and/or bromine weight content.

According to a second preferred embodiment, the iodine and/or bromine cure sites are comprised as terminal groups of the (per)fluoroelastomer polymer chain; the fluoroelastomer according to this embodiment is generally obtained by addition to the polymerization medium during fluoroelastomer manufacture of anyone of:
iodinated and/or brominated chain-transfer agent(s); suitable chain-chain transfer agents are typically those of formula R_{f}(I)ₓ(Br)_{y}, in which R_{f} is a (per)fluoroalkyl or a (per)fluorochloroalkyl containing from 1 to 8 carbon atoms, while x and y are integers between 0 and 2, with 1≤x+y≤2 (see, for example, patents U.S. Pat. No. 4,243,770 (DAIKIN IND LTD) and U.S. Pat. No. 4,943,622 (NIPPON MEKTRON KK); and
alkali metal or alkaline-earth metal iodides and/or bromides, such as described notably in patent U.S. Pat. No. 5,173,553 (AUSIMONT SRL).

Among specific compositions of said (per)fluoroelastomer, which are suitable for the purpose of the present invention, mention can be made of fluoroelastomers having the following compositions (in mol %):

(i) vinylidene fluoride (VDF) 35-85%, hexafluoropropene (HFP) 10-45%, tetrafluoroethylene (TFE) 0-30%, perfluoroalkyl vinyl ethers (PAVE) 0-15%, bis-olefin (OF) 0-5%;

(ii) vinylidene fluoride (VDF) 50-80%, perfluoroalkyl vinyl ethers (PAVE) 5-50%, tetrafluoroethylene (TFE) 0-20%, bis-olefin (OF) 0-5%;

(iii) vinylidene fluoride (VDF) 20-30%, C₂-C₈ non-fluorinated olefins (OI) 10-30%, hexafluoropropene (HFP) and/or perfluoroalkyl vinyl ethers (PAVE) 18-27%, tetrafluoroethylene (TFE) 10-30%, bis-olefin (OF) 0-5%;

(iv) tetrafluoroethylene (TFE) 50-80%, perfluoroalkyl vinyl ethers (PAVE) 20-50%, bis-olefin (OF) 0-5%;

(v) tetrafluoroethylene (TFE) 45-65%, C₂-C₈ non-fluorinated olefins (OI) 20-55%, vinylidene fluoride 0-30%, bis-olefin (OF) 0-5%;

(vi) tetrafluoroethylene (TFE) 32-60% mol %, C₂-C₈ non-fluorinated olefins (01) 10-40%, perfluoroalkyl vinyl ethers (PAVE) 20-40%, fluorovinyl ethers (MOVE) 0-30%, bis-olefin (OF) 0-5%;

(vii) tetrafluoroethylene (TFE) 33-75%, perfluoroalkyl vinyl ethers (PAVE) 15-45%, vinylidene fluoride (VDF) 5-30%, hexafluoropropene HFP 0-30%, bis-olefin (OF) 0-5%;

(viii) vinylidene fluoride (VDF) 35-85%, fluorovinyl ethers (MOVE) 5-40%, perfluoroalkyl vinyl ethers (PAVE) 0-30%, tetrafluoroethylene (TFE) 0-40%, hexafluoropropene (HFP) 0-30%, bis-olefin (OF) 0-5%;

(ix) tetrafluoroethylene (TFE) 20-70%, fluorovinyl ethers (MOVE) 30-80%, perfluoroalkyl vinyl ethers (PAVE) 0-50%, bis-olefin (OF) 0-5%.

More preferred (per)fluoroelastomers are those comprising vinylidene fluoride (VDF) 35-85%, hexafluoropropene (HFP) 10-45%, tetrafluoroethylene (TFE) 0-30%, perfluoroalkyl vinyl ethers (PAVE) 0-15%, bis-olefin (OF) 0-5%.

Suitable examples of (per)fluoroelastomers are commercially available from SOLVAY SPECIALTY POLYMERS ITALY S.p.A. under the tradename Tecnoflon®, such as for example Tecnoflon® P757 and Tecnoflon® FOR 539.

Preferably, said silicone elastomer has a T_{g} of less than −10° C., more preferably of less than -30° C., and even more preferably of less than −50° C. as measured as measured according to ASTM D-3418.

Typically, said silicone elastomer comprises recurring units derived from silicon-containing monomers, and optionally further hydrogenated monomers and/or (per)fluorinated monomers as disclosed above.

By the expression “silicon-containing monomer”, it is hereby intended to denote a linear or branched monomer containing alternating silicon and oxygen atoms.

Non limitative examples of suitable silicon-containing monomers include:
silane, such as CH₂═CH₂—Si(R_{f7})₃ wherein each of R_{f7} is independently selected from H, F and C₁-C₃ alkyl;
siloxane of formula (R)₃Si—O—Si(R)₃ and (R)₂Si(OH)₂, wherein each R is independently selected from H, linear or branched alkyl groups having from 1 to 6 carbon atoms, preferably methyl group, or phenyl group.

Typically, said silicone elastomer is a polyorganosiloxane-based silicone rubber base, such as a polydimethyl siloxane containing crosslinking groups having hydroxyl, vinyl or hexenyl groups, or a polymethylphenyl siloxane.

Suitable examples of silicone elastomers are the products sold by Dow Corning Corp. (U.S.A.) under the trade name Silastic, such as Silastic 35U and Silastic TR-55 (dimethyl vinyl terminated, dimethyl organosiloxane).

Said groups (N) are not particularly limited, provided that it contains at least one nitrogen atom. Examples said of groups (N) are amino, amide, imino, nitrile, urethane and urea groups.

Preferably, said compound (M) comprises at least one metal selected from the group consisting of Ni, Cu, Pd, Co, Ag, Au, Pt, Sn and alloys thereof. More preferably, said compound (M) comprises Ni, Pd, Co and alloys thereof, preferably with phosphorous.

According to a preferred embodiment, the hose according to the present invention comprises layer (L) as the only layer.

Preferably, said layer (L) has a thickness in the range from 0.1 mm to 25 mm, more preferably from 0.5 mm to 15 mm.

Optionally, one further layer [layer (L₂)] can be provided onto the external surface, i.e. surface (S_{e-NM}) or surface (S_{e-NMM}), of said layer (L).

Said layer (L₂) provides the advantage of protect the external surface of layer L comprising said compound (M) from external agents, notably against corrosion and scratch, while providing better mechanical properties to the fuel hose.

The thickness of said layer (L₂) is not particularly limited and can be selected from the skilled person depending on the intended final use of the hose according to the present invention. For example, layer (L₂) has a thickness between 0.01 mm to 25 mm, more preferably from 0.05 mm to 12 mm.

Said layer (L₂) is preferably made from a composition comprising at least one elastomer comprising recurring units derived from at least one hydrogenated monomer.

Preferably, said at least one hydrogenated monomer is selected in the group defined above for layer (L).

Under step (i) of the process of the present invention, said elastomeric composition (C) typically comprises at least one elastomer, for example in the form of slabs, powder, crumbs, liquids, gels; and further ingredients.

Suitable further ingredients and their amounts can be selected by the skilled person, depending on the type of elastomer used, the conditions used in the cross-linking step and/or the properties desired in the final article.

Typically, further ingredients can be selected from the following:
curing agents, such as polyhydroxylic compounds (for example Bisphenol A), triallyl-isocyanurate (TAIC) and organic peroxide (for example di-tertbutyl peroxide, 2,4-dichloro benzoyl peroxide, dibenzoyl peroxide, bis(1,1-diethylpropyl)peroxide, bis(1-ethyl-1-methylpropyl)peroxide, 1,1-diethylpropyl-1-ethyl-1-methylpropyl-peroxide, 2,5-dimethyl-2,5-bis(tert-amylperoxy)hexane, dicumyl peroxide, di-tert-butyl perbenzoate, bis[1,3-dimethyl-3-(tert-butylperoxy)butyl] carbonate and 2,5-bis(tert-butylper- oxy)-2,5-dimethylhexane, which is sold under the trade name Luperox® 101XL45);
metal compounds, in particular bivalent metal oxides and/or hydroxide, such as MgO, ZnO and Ca(OH)₂; salts of a weak acid, such as Ba, Na, K, Pb, Ca stearate, benzoates, carbonates, oxalates, or phopshites; and mixtures thereof; and
conventional additives, in particular fillers, such as carbon black and fumed silica; accelerators, such as ammonium, phosphonium and aminophosphonium salt; thickeners; pigments; antioxideant; stabilizers; processing aids.

Preferably, in composition (C), said curing agents are in an amount of from 0.5 to 15 phr (i.e., parts by weight per 100 parts by weight of the elastomer), more preferably of from 2 to 10 phr.

Preferably, in composition (C), said metal compounds are in an amount of from 0.5 to 15 phr, more preferably of from 1 to 10 phr.

Preferably, in composition (C), said conventional additives are in an amount of from 0.5 to 50 phr, more preferably of from 3 to 40 phr.

Also, when the elastomer is a silicone elastomer, the composition (C) can further comprise an organosilane coupling agent, preferably in an amount of from 0.1 wt. % to 1.5 wt. % of said composition (C).

Said composition (C) is typically manufactured by using standard methods.

Typically, all the ingredients are first mixed together. Mixer devices such as internal mixers or open mill mixers can be used.

Under step (ii), processing of composition (C) is preferably performed by extruding or curing said composition (C).

The conditions for extruding or curing said composition (C) can be selected by the skilled person depending on the starting elastomer and on the thickness desired in the final product.

When the elastomer is a fluoroelastomer, curing can be performed at a temperature of from 100° C. to 250° C., preferably from 150° C. to 200° C., for a time of from 5 to 30 minutes.

Alternatively, when the elastomer is a silicone elastomer, curing can be performed at a temperature of from 100° C. to 200° C., for a time of from 5 to 15 minutes.

Preferably, said step (iii) is performed by treating said surface (Sₑ) in the presence of a nitrogen-containing gas.

Under step (iii) of the present invention, said nitrogen-containing gas is preferably selected from N₂, NH₃ or mixtures thereof, optionally in admixture with nitrogen-free gas such as CO₂ and/or H₂. More preferably, said nitrogen-containing gas is a mixture of N₂ and H₂.

The gas rate can be selected by the skilled person. Good results have been obtained by using gas flow between 5 nl/min and 15 nl/min, preferably of about 10 nl/min.

Preferably, said step (iii) is performed by an atmospheric plasma process.

Preferably, said atmospheric plasma process is performed under atmospheric pressure and with an equivalent corona dose of from 50 Wmin/m² to 30,000 Wmin/m², more preferably of from 500 Wmin/m² to 15000 Wmin/m².

Advantageously, said surface (Sₑ) is continuously treated by said atmospheric plasma process in the presence of a nitrogen-containing gas, so as to provide a nitrogen-containing surface (S_{e-N}).

The Applicant has found that the so-treated surface (Sₑ-_{N}) provides outstanding adhesion to the metal compound, applied thereto as disclosed below.

Preferably, under step (iv) of the present invention, said composition (C1) is in a solution or a colloidal suspension of the metallization catalyst in a suitable solvent, such as water.

Preferably, step (iv) is performed by dipping the hose as obtained in step (ii) in said composition (C1).

Preferably, compounds that may be employed as metallization catalysts in the method of the present invention can be provided in the form of metal, ion or complex thereof.

When the metallization catalyst is in the form of a metal ion, the method according to the present invention comprises after step (iv) and before step (v), a step (vi-b) of reducing the metallization catalyst in the form of ion to metal.

Preferably, said metallization catalyst are selected in the group comprising

Pd, Pt, Rh, Ir, Ni, Cu, Ag and Au catalysts.

More preferably, the metallization catalyst is selected from Pd catalysts, such as PdCl₂.

Preferably, under step (v), said composition (C2) is an electroless metallization plating bath, comprising at least one compound (M1), at least one reducing agent, at least one liquid medium and, optionally, one or more additives.

Preferably, said compound (M1) comprises one or more metal salts. More preferably, said compound (M1) preferably comprises one or more metal salts of the metals listed above with respect to compound (M).

Preferably, said reducing agent is selected from the group comprising formaldehyde, sodium hypophosphite, hydrazine, glycolic acid and glyoxylic acid.

Preferably, said liquid medium is selected from the group comprising water, organic solvents and ionic liquids.

Among organic solvents, alcohols are preferred such as ethanol.

Non-limitative examples of suitable ionic liquids include, notably, those comprising as cation a sulfonium ion or an imidazolium, pyridinium, pyrrolidinium or piperidinium ring, said ring being optionally substituted on the nitrogen atom, in particular by one or more alkyl groups with 1 to 8 carbon atoms, and on the carbon atoms, in particular by one or more alkyl groups with 1 to 30 carbon atoms.

Preferably, the ionic liquid is advantageously selected from those comprising as anion those chosen from halides anions, perfluorinated anions and borates.

Preferably, additives are selected from the group comprising salts, buffers and other materials suitable for enhancing stability of the catalyst in the liquid composition.

Preferably, said step (v) is performed at a temperature above 30° C., for example between 40° C. and 50° C.

Advantageously, according to an embodiment, step (v) is performed so as to provide a continuous layer comprising compound M onto said surface (S_{e-NC}), i.e. a layer that completely covers said surface (S_{e-NC}).

Embodiments wherein said layer comprising compound M covers only certain areas of said surface (S_{e-NC}) are also encompasses by the present invention.

The thickness of the layer comprising compound M is not particularly limited. For example, said layer has a thickness of from 1 nm to 10 μm, preferably from 10 nm to 1 μm.

Preferably, said steps (iv) and (v) are performed as a single step [step (iii-D)], more preferably by electroless deposition.

By “electroless deposition” it is meant a redox process typically carried out in a plating bath between a metal cation and a proper chemical reducing agent suitable for reducing said metal cation in its elemental state.

The preferred conditions disclosed above with respect to step (iv) and step (v) apply whether step (iv) and step (v) are performed separately or when step (iv) and step (v) are performed as a single step (iii-D).

Optionally, the above method comprises after step (v), step (vi) of applying a composition [composition (03)] containing at least one metal compound [compound (M2)] onto said surface (S_{e-NM}), so as to provide an external surface (S_{e-NMM}) comprising groups (N) and at least two compounds (M).

Preferably, said composition (C3) is an electrolytic solution, comprising at least one compound (M2), at least one metal halide and, optionally, at least one ionic liquid as defined above.

Said compound (M2) can be the same or different from said compound (M1).

Preferably, said compound (M2) is a metal salt deriving from Al, Ni, Cu, Ag, Au, Cr, Co, Sn, Ir, Pt and alloys thereof.

Preferably, said metal halide is PdCl₂.

Preferably, said step (vi) is performed by electro-deposition.

Within the present description and in the following claims, by “electro-deposition” it is meant a process using electrical current to reduce metal cations from an electrolytic solution.

Optionally, the above method comprises after step (v) or after step (vi), step (vii) of applying a composition [composition (C4)] containing at least one hydrogenated elastomer, so as to provide a layer [layer (L₂)] onto the external surface of said at least one layer L.

Preferably, said step (vii) is performed by extruding or curing said composition (C4). Step (vii) can be performed using conditions and processes known by the skilled person and selecting the parameters depending on the starting hydrogenated elastomer and on the thickness desired in the final product.

Should the disclosure of any patents, patent applications, and publications which are incorporated herein by reference conflict with the description of the present application to the extent that it may render a term unclear, the present description shall take precedence.

The present invention will be now described in more detail with reference to the following examples, whose purpose if merely illustrative and not limitative of the scope of the invention.

### Experimental Part

Materials
Tecnoflon® P757 fluoroelastomer having Mooney viscosity measured at 120° C. according to ASTM D1646 of 21 MU, was supplied by Solvay Specialty Polymers Italy S.p.A.
Tecnoflon® FOR 539 fluoroelastomer having Mooney viscosity measured at 120° C. according to ASTM D1646 of 21 MU, was supplied by Solvay Specialty Polymers Italy S.p.A.
N990 MT carbon black was supplied by Cancarb
Luperox® 101XL45: 2,5-bis(tert-butylperoxy)-2,5-dimethylhexane, blend with calcium carbonate and silica, with 45 wt. % of solid content, was supplied by Total Petrochemicals USA, Inc.
DRIMIX® 75% TAIC: triallyl isocyanurate, with 75 wt. % of solid content, was supplied by Finco s.r.l.
Maglite® DE : magnesium oxide having a surface are of about 120 m²/g, was supplied by Merck
Rhenofit® CF : calcium hydroxide having a density of about 2.2 g/cm³ was supplied by Rhein Chemie

### EXAMPLE 1

### Production of Test Specimens in the Form of Plaques

Step 1

The ingredients listed in the following Tables 1 and 2 were mixed together in an open mill mixer:

TABLE 1
Composition A

| Ingredients | Amount (phr) |
|---|---|
| Tecnoflon ® P757 | 100 |
| N990 MT carbon black | 30 |
| Luperox ® 101XL45 | 3 |
| DRIMIX ® 75% TAIC | 4 |

TABLE 2
Composition B

| Ingredients | Amount (phr) |
|---|---|
| Tecnoflon ® FOR 539 | 100 |
| N990 MT carbon black | 30 |
| Maglite ® DE | 3 |
| Rhenofit ® CF | 6 |

Each composition A and B thus obtained was press-cured for 5 minutes at 170° C., so as to form two plaques (2 plaques from composition A and 2 plaques from composition B) of 2 mm thick and 130 mm of side.

The plaques obtained from composition A were then post-cured in an oven (in air) for 24 hours at 230° C., and the plaques obtained from composition B were post-cured in an oven (in air) for 24 hours at 250° C.

All the plaques obtained were then cleaned with a lab cloth soaked with isopropyl alcohol (IPA), in order to remove dirt and contaminants.

Step 2

The surface of plaques obtained in step 1 above was treated at atmospheric pressure by a radio-frequency plasma discharge process, using Plasmatreater® AS400 instrument, using the following conditions:

etching gas: N₂,

working frequency: 20 kHz

voltage: 0.3 kV.

Step 3

The surface of the plaques obtained after step 2 above was coated with metallic nickel by electroless plating.

First, the treated surface of the plaques was activated by immersion in an aqueous solution containing 0.03 g/L of PdCl₂ for 3 minute (pH=9.5), resulting in the treated surface of the (P1) sample being entirely coated with Pd particles at a high density.

The so activated surface was then immersed in an aqueous plating bath containing 25 g/L of NiSO₄, 6 g/L of sodium borohydride, 15 g/L of malic acid and organic additives. The plating temperature was 50° C. and its pH value was 9.

The thickness of the nickel layer coated onto the treated surface was 0.2 pm as measured by SEM.

### EXAMPLE 2A

### Methanol Permeation Test

Methanol permeation was measured according to an internal procedure developed on the base of the ASTM D814. The test apparatus consisted of a jar where methanol was placed and on which the test specimens were mounted while the jar was in an upright position. The so assembled jar was inverted in order to allow the liquid to enter in direct and constant contact with the rubber specimens. The assembly was held at the temperature of 40° C. The mass of liquid lost from the specimen's side was measured to evaluate the permeation rate (P parameter).

Two plaques from composition A (plaque A1 plaque A2) and two plaques from composition B (plaque B1 and plaque B2), prepared as described in Example 1 above, were subjected to the methanol permeation test following the procedure described above. The four Plaques were mounted with the metallic layer facing methanol.

As comparison, a pristine plaque was prepared from composition A (plaque 3C*) without the coating (in other words, step 2 and step 3 of the procedure described in Example 1 were not performed) and subjected to the same test.

All the Plaques had a thickness of about 1.20 mm.

The results are provided in the following Table 3 and expressed as average results of Parameter P.

TABLE 3

| | Parameter P |
|---|---|
| | [g · mm/m² · d] - |
| Plaque | average value |
| A1, A2, B1, B2 | 20 |
| 3C(*) | 390 |

(*)comparison

### EXAMPLE 2B

### CE22 Permeation Test

CE22 (a mixture of 38 wt. % toluene, 39 wt. % i-octane and 22 wt. % ethanol) permeation was measured according to an internal procedure developed on the base of the ASTM D814. The test apparatus was the same used to evaluate permeation to methanol in Example 2A. The mass of liquid lost from the specimen's side was measured to evaluate the permeation rate (P parameter).

Two plaques from composition B (plaque B3 and plaque B4), prepared as described in Example 1 above, were subjected to the CE22 permeation test following the procedure described above. The Plaques were mounted with the metallic layer facing CE22.

As comparison, a pristine plaque was prepared from composition B (plaque 4C*) without the coating (in other words, step 2 and step 3 of the procedure described in Example 1 were not performed) and subjected to the same test.

All the Plaques had a thickness of about 1.20 mm.

The results are provided in the following Table 4 and expressed as average results of Parameter P.

TABLE 4

| | Parameter P |
|---|---|
| | [g · mm/m² · d] - |
| Plaque | average value |
| B3 | 57 |
| B4 | 57 |
| 4C(*) | 105 |

(*)comparison

### EXAMPLE 3

### Evaluation of Adhesion of the Metallic Layer

The adhesion of the metallic layer was evaluated according to the following procedure.

Using a cutting tool, two series of perpendicular cuts were performed on the metallic layer of the plaques, in order to create a lattice pattern on them. A piece of tape was then applied and smoothened over the lattice and removed with an angle of 180° with respect to the metallic layer.

The adhesion of metallic layer was then assessed by comparison of the lattice of cuts with the ASTM D3359 standard procedure. The classification of test results ranged from 5B to 0B, whose descriptions are depicted in Table 5 herein below.

TABLE 5

| ASTM D3359 | |
|---|---|
| Classification | Description |
| 5B | The edges of the cuts are completely smooth; |
| | none of the squares of the lattice is detached. |
| 4B | Detachment of flakes of the coating at the |
| | intersections of the cuts. A cross cut area not |
| | significantly greater than 5% is affected. |
| 3B | The coating has flaked along the edges and/or at |
| | the intersection of the cuts. A cross cut area |
| | significantly greater than 5%, but not significantly |
| | greater than 15% is affected. |
| 2B | The coating has flaked along the edges of the cuts |
| | partly or wholly in large ribbons, and/or it has |
| | flaked partly of wholly on different parts of the |
| | squares. A cross cut area significantly greater than |
| | 15%, but not significantly greater than 65%, is |
| | affected. |
| 1B | The coating has flaked along the edges of the cuts |
| | in large ribbons and/or some squares have |
| | detached partly or wholly. A cross cut area |
| | significantly greater than 35%, but not significantly |
| | greater than 65%, is affected. |
| 0B | Any degree of flaking that cannot be classified |
| | even by classification 1B. |

The average adhesion value was as follows:
plaques A1 and A2=5B;
plaque B1 and B2=5B

The above results demonstrated the excellent adhesion achieved in the elastomer hose according to the present invention.

### EXAMPLE 4

### Evaluation of Chemical Resistance

Six DINS2 samples were die-cut out from a plaque obtained from Composition B and treated following the procedure described in Example 1 above. Three of the plaques thus prepared (herein after globally indicated as Plaque B6) were subjected to the test as described herein below. The remaining three (herein after globally indicated as Plaque B5) where characterized without undergo chemical resistance test.

The chemical resistance was measured by dipping each sample in acetic acid (pH 2.5) at 100° C. for 500 hours. After that, weight and volume variation were evaluated to assess liquid absorption.

The mechanical properties were measured using a suitable instrument from Instron®, before and after the contact with the acetic acid.

As comparison, six pristine samples were prepared from composition B without the coating (in other words, step 2 and step 3 of the procedure described in Example 1 were not performed). Three samples were subjected to the same test to evaluate the chemical resistance to acetic acid (herein after globally referred to as Plaque 6C*) while the other three samples were characterized without performing the test (herein after globally referred to as Plaque 5C*).

The results are provided in the following Table 6.

TABLE 6

| | | Load at break | Elongation at | Shore A |
|---|---|---|---|---|
| Sample | M50 [MPa] | [MPa] | break [%] | 3″ [pt] |
| B5^{(§)} | 3.7 | 13.6 | 154 | 75 |
| B6 | 3.7 | 11.5 | 156 | 65 |
| Delta | — | −15% | +1.3% | −10 pt |
| 5C(*)^{(§)} | 3.8 | 14.2 | 152 | 74 |
| 6C(*) | 4.7 | 7.5 | 78 | 64 |
| Delta | +24% | −47% | −49% | −10 pt |

(*)comparison
^{(§)}evaluation before the test
M50 = load at 50% elongation
Shore A was measured according to ASTM D2240

The above results showed that between samples B5 and B6 there was no variation in load at 50% elongation and elongation at break, indicating that the elastic behaviour was not influenced by chemicals and, hence, that the metallic barrier was effective.

Differently, the above results showed that between samples 5C and 6C the uncoated sample became more stiff after chemical resistance test and hence a higher load was needed to deform the specimen (M50) and break (elongation at break) occurred at a lower deformation.

Weight and volume variation of Plaques B6 and 6C(*) were also measured. The results are provided in the following Table 7.

TABLE 7

| Sample | Weight variation (%) | Volume variation (%) |
|---|---|---|
| 6C(*) | +74% | +136% |
| B6 | +46% | +85% |

(*)comparison

The above results showed that a lower increase in weight and volume was obtained for sample B6 according to the invention compared to comparative sample 6C, which demonstrated that the metallic coating acted as barrier, reducing the absorption of chemicals.

1. A hose comprising at least one layer L, said layer L being made from a composition comprising at least one elastomer and having an internal surface (Sᵢ) and an external surface (S_{e-NM}), said surface (S_{e-NM}) comprising nitrogen-containing groups (N) and at least one metal compound (M).

2. The hose according to claim 1, wherein said elastomer comprises recurring units derived from at least one at least one (per)fluorinated monomer and/or at least one hydrogenated monomer.

3. The hose according to claim 2, wherein said at least one (per)fluorinated monomer is selected from the group consisting of:
C₃-C₈ perfluoroolefins;
C₂-C₈ hydrogenated fluoroolefins;
chloro- and/or bromo- and/or iodo-C₂-C₆ fluoroolefins;
CH₂═CH—R_{f0} wherein R_{f0} is a C₁-C₆ (per)fluoroalkyl or a C₁-C₆ (per)fluorooxyalkyl having one or more ether groups;
CH₂═CFOR_{f1}, wherein R_{f1} is a C₁-C₆ fluoro- or perfluoroalkyl group;
CF₂═CFOR_{f2}, wherein R_{f2} is C₁-C₁₂ alkyl or (per)fluoroalkyl group C₁-C₁₂ oxyalkyl; C₁-C₁₂ (per)fluorooxyalkyl group, optionally comprising one or more ether groups; a group of formula —CF₂OR_{f3} in which R_{f3} is a C₁-C₆ fluoro- or perfluoroalkyl or a C₁-C₆ (per)fluorooxyalkyl group comprising one or more ether groups; or R_{f2} comprises a carboxylic or sulfonic acid group, in its acid, acid halide or salt form;
fluorodioxoles; and
fluorosilanes.

4. The hose according to claim 2, wherein said at least one hydrogenated monomer is selected from the group consisting of C₂-C₈ non-fluorinated olefins (OI); diene monomers; vinyl monomers; acrylic monomers;
styrene monomers; nitrile rubber; and silicon-containing monomers.

5. The hose according to claim 1, wherein said elastomer is a (per)fluoroelastomer or a silicone elastomer.

6. The hose according to claim 5, wherein said (per)fluoroelastomer comprises recurring units derived from:
C₃-C₈ perfluoroolefins;
C₂-C₈ hydrogenated fluoroolefins;
CF₂═CFOR_{f1}, wherein R_{f1} is a C₁-C₆ fluoro- or perfluoroalkyl group or a group of formula —CFOCF₂OR_{f2} wherein R_{f2}is a C₁-C₆ fluoro- or perfluoroalkyl group; and
fluorosilanes.

7. The hose according to claim 5, wherein said (per)fluoroelastomer comprises cure sites, either as pendant groups bonded to certain recurring units or as ends groups of the polymer chain, said cure sites comprising at least one iodine or bromine atom.

8. The hose according to claim 5, wherein said (per)fluoroelastomer is a fluoroelastomer selected from compositions (i) to (ix), wherein the amounts are given as mol %:
(i) vinylidene fluoride (VDF) 35-85%, hexafluoropropene (HFP) 10-45%, tetrafluoroethylene (TFE) 0-30%, perfluoroalkyl vinyl ethers (PAVE) 0-15%, bis-olefin (OF) 0-5%;
(ii) vinylidene fluoride (VDF) 50-80%, perfluoroalkyl vinyl ethers (PAVE) 5-50%, tetrafluoroethylene (TFE) 0-20%, bis-olefin (OF) 0-5%;
(iii) vinylidene fluoride (VDF) 20-30%, C₂-C₈ non-fluorinated olefins (OI) 10-30%, hexafluoropropene (HFP) and/or perfluoroalkyl vinyl ethers (PAVE) 18-27%, tetrafluoroethylene (TFE) 10-30%, bis-olefin (OF) 0-5%;
(iv) tetrafluoroethylene (TFE) 50-80%, perfluoroalkyl vinyl ethers (PAVE) 20-50%, bis-olefin (OF) 0-5%;
(v) tetrafluoroethylene (TFE) 45-65%, C₂-C₈ non-fluorinated olefins (OI) 20-55%, vinylidene fluoride 0-30%, bis-olefin (OF) 0-5%;
(vi) tetrafluoroethylene (TFE) 32-60% mol %, C₂-C₈ non-fluorinated olefins (oi) 10-40%, perfluoroalkyl vinyl ethers (PAVE) 20-40%, fluorovinyl ethers (MOVE) 0-30%, bis-olefin (OF) 0-5%;
(vii) tetrafluoroethylene (TFE) 33-75%, perfluoroalkyl vinyl ethers (PAVE) 15-45%, vinylidene fluoride (VDF) 5-30%, hexafluoropropene HFP 0-30%, bis-olefin (OF) 0-5%;
(viii) vinylidene fluoride (VDF) 35-85%, fluorovinyl ethers (MOVE) 5-40%, perfluoroalkyl vinyl ethers (PAVE) 0-30%, tetrafluoroethylene (TFE) 0-40%, hexafluoropropene (HFP) 0-30%, bis-olefin (OF) 0-5%;
(ix) tetrafluoroethylene (TFE) 20-70%, fluorovinyl ethers (MOVE) 30-80%, perfluoroalkyl vinyl ethers (PAVE) 0-50%, bis-olefin (OF) 0-5%.

9. The hose according to claim 1, wherein said groups (N) are selected from the group consisting of: amino, amide, imino, nitrile, urethane and urea groups.

10. The hose according to claim 1, wherein said compound (M) comprises at least one metal selected from the group consisting of Ni, Cu, Pd, Co, Ag, Au, Pt, Sn and alloys thereof.

11. The hose according to claim 1, wherein said hose comprises, on an external surface of said layer (L), one further layer (L₂), said layer (L₂) being made from a composition comprising at least one elastomer comprising recurring units derived from at least one hydrogenated monomer, wherein said at least one hydrogenated monomer is selected from the group consisting of: C₂-C₈ non-fluorinated olefins (OI) diene monomers; vinyl monomers; acrylic monomers; styrene monomers; nitrile rubber; and silicon-containing monomers.

12. A method for supplying or transporting fuel drawn up from a fuel tank to fuel injection valves of an engine, wherein the supply or transport of the fuel is performed using the hose according to claim 1.

13. A method for manufacturing a hose, said method comprising:
processing a composition (C), wherein composition (C) comprises at least one elastomer, so as to provide a hose having an internal surface (Sᵢ) and an external surface (Sₑ);
forming nitrogen-containing groups (N) onto said surface (Sₑ) so as to provide a hose having a nitrogen-containing external surface (S_{e-N});
contacting said surface (S_{e-N}) with a composition (C1), wherein composition (C1) comprises at least one metallization catalyst, so as to provide a hose having an external surface (S_{e-NC}), wherein surface (S_{e-NC}) contains groups (N) and at least one metallization catalyst;
contacting said surface (S_{e-NC}) with a composition (C2), wherein composition (C2) contains at least one metal compound (M1), so as to provide a hose having an internal surface (Sᵢ) and an external surface (S_{e-NM}), said surface (S_{e-NM}) comprising groups (N) and at least one compound (M).

14. The method according to claim 13, said method further comprising applying a composition (C3), wherein composition (C3) contains at least one metal compound (M2), onto said surface (S_{e-NM}) so as to provide an external surface (S_{e-NM}) comprising groups (N) and at least two compounds (M).

15. The method according to claim 13, said method further comprising applying a composition (C4), wherein composition (C4) contains at least one hydrogenated elastomer, onto said surface (S_{e-NM}) so as to provide a layer (L₂) on the external surface of said surface (S_{e-NM}).

16. The method according to claim 14, said method further comprising applying a composition (C4), wherein composition (C4) contains at least one hydrogenated elastomer, onto said surface (S_{e-NM}) so as to provide a layer (L₂) on the external surface of said surface (S_{e-NMM}).

17. The hose according to claim 3, wherein:
R_{f1} is CF₃, C₂F₅ or C₃F₇,
R_{f2} is CF₃, C₂F₅, C₃F₇ or perfluoro-2-propoxy-propyl; and
R_{f3} is —C₂F₅—O—CF₃.

18. The hose according to claim 6, wherein said (per)fluoroelastomer comprises recurring units derived from:
tetrafluoroethylene (TFE); hexafluoropropene (HFP); vinylidene fluoride (VDF); vinyl fluoride; 1,2-difluoroethylene; trifluoroethylene (TrFE); CF₂═CFOR_{f1} wherein R_{f1} is CF₃, C₂F₅, C₃F₇ or —CFOCF₂OR_{f2} wherein R_{f2} is CF₃, C₂F₅ or C₃F₇; CF₃—C₂H₄—Si(R_{f3})₃ wherein each of R_{f3} is independently selected from Cl, C₁-C₃ alkyl or C₁-C₃ alkoxy; CH₂═CH₂—Si(R_{f4})₃ wherein each of R_{f4} is selected from H, F and C₁-C₃ alkyl; or mixtures thereof

19. The hose according to claim 7, wherein said cure sites comprise at least one iodine atom.
